(19) United States
(12) Patent Application Publication
(10) Pub. No.: US 2017/0267194 A1
(43) Pub. Date: Sep. 21, 2017

(54) POWER DELIVERY APPARATUS

(71) Applicant: YAZAKI CORPORATION, Tokyo (JP)

(72) Inventors: Yoshitake Aruga, Tochigi (JP); Shinichi Akiyama, Tochigi (JP); Sojiro Sato, Tochigi (JP); Takumi Komaba, Tochigi (JP); Norihiro Ohashi, Shizuoka (JP); Masayoshi Ozawa, Shizuoka (JP)

(21) Appl. No.: 15/454,430

(22) Filed: Mar. 9, 2017

(30) Foreign Application Priority Data
Mar. 17, 2016 (JP) 2016-054360

(51) Int. Cl. B60R 16/033; F02N 11/08

(52) U.S. Cl. CPC B60R 16/033; F02N 11/0862

(57) ABSTRACT

A power delivery apparatus (100) for a vehicle includes an upstream delivering portion (10) and a downstream delivering portion (20). The upstream delivering portion (10) includes: an internal input terminal (11); an external input terminal (12); and a connecting terminal (13). The internal input terminal (11), the external input terminal (12) and the connecting terminal (13) are different terminals from one another. The downstream delivering portion (20) includes: a connected terminal (23); a fuse portion (22a-22e) connected to the connected terminal (23); and a downstream output terminal (21a-21e) outputting the electric power via the fuse portion (22a-22e). The upstream delivering portion (10) and the downstream delivering portion (20) are independent members each other and are assembled to be integrated with each other to allow connecting the connecting terminal (13) and the connected terminal (23).

### CROSS-REFERENCES TO RELATED APPLICATION(S)

This application is based on and claims priority from Japanese Patent Application No. 2016-054360 filed on Mar. 17, 2016, and the entire contents of which are incorporated herein by reference.

### BACKGROUND

### Field of the Invention

The present invention relates to a power delivery apparatus for a vehicle capable of delivering electric power supplied from a power source.

### Description of Related Art

Power delivery apparatuses have been used to deliver electric power between various power sources and electric devices mounted on vehicles. For example, one of the power delivery apparatuses in the background art (hereinafter referred to as “background-art apparatus”) is an integrated molded article which includes a plurality of fusible links internally, and this apparatus is configured to be attached directly to power terminals including a battery post of a battery (on-vehicle power source, so-called 12V battery) mounted on a vehicle. In addition, the fusible links of this apparatus are configured to be connected to various electric devices mounted on the vehicle.

As for details of the above connection structure, refer to JP 2015-043291 A.

### SUMMARY

The aforementioned battery to which a background-art apparatus is attached directly is generally disposed in an engine room of a vehicle. Hence, the battery post (a terminal for rescue from battery exhaustion) which is a part of the battery is inevitably disposed in the engine room. This allows users to connect an external power source to the battery post easily at the time of battery exhaustion.

On the other hand, highly functional vehicles in recent years have a tendency to lack for a component installing space due to a large variety of components mounted in the vehicle (for example, in a hybrid car, such as a motor, an inverter, a control unit (PCU) for the inverter, and a power dividing mechanism, in addition to an engine, which has been conventionally mounted). Then, moving the battery (12V battery) disposed in an engine room in the background art toward outside the engine room (for example, around a trunk room) may solve the lack for the component installing space.

Unfortunately, when the arrangement of the battery is changed carelessly, the changed arrangement may cause difficultly in connecting an external power source to the battery post at the time of battery exhaustion, and thus reducing usability of the vehicle. Further, a fundamental change in design may be required for a large number of components such as a background art apparatus (power delivery apparatus) designed on the assumption that the battery is disposed in the engine room. This may increase the manufacturing cost of the vehicle. Hence, it is not easy to change the arrangement of the battery, not only from the viewpoint of usability but also from manufacturing cost.

An object of the present invention is to provide a power delivery apparatus that enables users to easily handle battery exhaustion and that reduces change of design of various kinds of components as far as possible even when a battery is disposed outside an engine room.

Embodiments of the present invention provide the following items (1) to (4).
(1) A power delivery apparatus for a vehicle, the apparatus comprising:

an upstream delivering portion delivering electric power supplied from a power source; and a downstream delivering portion delivering the electric power via the upstream delivering portion,

the upstream delivering portion including:

an internal input terminal connected to an on-vehicle power source; an external input terminal connected to an external power source outside the vehicle; and a connecting terminal outputting electric power inputted from at least one of the internal input terminal and the external input terminal to the downstream delivering portion,

the internal input terminal, the external input terminal and the connecting terminal being different terminals from one another,

the downstream delivering portion including:

a connected terminal receiving the electric power outputted from the connecting terminal; a fuse portion connected to the connected terminal; and a downstream output terminal outputting the electric power via the fuse portion to an electric device mounted on the vehicle,

the upstream delivering portion and the downstream delivering portion being independent members each other and being assembled to be integrated with each other to allow connecting the connecting terminal and the connected terminal.
(2) The power delivery apparatus according to item (1), wherein

the upstream delivering portion includes:

an upstream output portion outputting electric power to another electric device than the electric device connected to the downstream output terminal.
(3) The power delivery apparatus according to item (1) or item (2), wherein

the downstream delivering portion further includes:

a direct output terminal outputting the electric power inputted to the connected terminal without passing through the fuse portion.
(4) The power delivery apparatus according to any one of item (1) to item (3), wherein

the downstream delivering portion includes:

a plurality of the downstream output terminals; and a specific fuse portion as the fuse portion connected to one of the plurality of the downstream output terminals,

the specific fuse portion having capacity enough to serve as a main fuse in a relay box mounted on the vehicle.

According to first aspect of the invention, relating to the item (1), the delivery apparatus is configured to integrally have the internal input terminal that can be connected to an on-vehicle power source (battery), the external input terminal (so-called jump post) that can be connected to an external power source, and the fuse portion (for example, a fusible link) corresponding to an electric device of a vehicle. Accordingly, when the power delivery apparatus is, for example, disposed in an engine room and the battery and the internal input terminal are connected to each other through a power line such as an electric wire, the external input terminal (jump post) can be located in the engine room even if the battery is located outside the engine room. Thus, handling at the time of battery exhaustion is not different from that when the battery is in the engine room. Further, the fuse portion is also located in the engine room. Thus, change of design of peripheral components can be avoided as far as possible.

Hence, a power delivery apparatus according to this aspect of the invention enables users to easily handle battery exhaustion and reduces change of design of various kinds of components as far as possible even when a battery is disposed outside an engine room.

Further, the power delivery apparatus relating to the item (1) also has advantages as follows.

First, the upstream delivering portion and the downstream delivering portion are separate parts, which are independent of each other. For example, the upstream delivering portion is set as a common part (general-purpose component) independent of the type of the vehicle, and the downstream delivering portion is set as an individual part (optional component) designed based on a specification required uniquely for the type of the vehicle. In this case, change of design may be performed only on the downstream delivering portion when the type of vehicle is changed. Accordingly, change of design all over the power delivery apparatus is not required uniquely for the type of the vehicle. Change in the specification of a vehicle can be dealt with easily and at a low cost accordingly in comparison with a case where the upstream delivering portion and the downstream delivering portion are not separate parts.

Secondly, the upstream delivering portion has the internal input terminal that is connected to the on-vehicle power source (battery), as another terminal than the connecting terminal that is connected to the connected terminal of the downstream delivering portion. Accordingly, no other terminal is connected to the internal input terminal in a state where the upstream delivering portion and the downstream delivering portion have been assembled to each other (a state where the connecting terminal of the upstream delivering portion and the connected terminal of the downstream delivering portion have been connected to each other). Thus, the power delivery apparatus and the on-vehicle power source can be connected to each other only if the on-vehicle power source and the internal input terminal are connected to each other in a subsequent step (for example, a step of installation on a vehicle in a product delivery destination such as a car maker). On the other hand, when the internal input terminal and the connecting terminal are not separated from each other (but shared with each other), the on-vehicle power source and the internal input terminal can be connected to each other after the internal input terminal and the connecting terminal are released from their connection (for example, a fastening bolt is removed) in the subsequent step. Accordingly, workability in the subsequent step can be improved in comparison with the case where the internal input terminal and the connecting terminal are not separated (but shared).

According to second aspect of the invention, relating to the item (2), an electric device to which electric power is supplied from the upstream delivering portion and an electric device to which electric power is supplied from the downstream delivering portion can be selected individually and desirably. Accordingly, for example, a relay box (and electric devices connected to the relay box) may be selected as the former electric device, and another electric device than the former may be selected as the latter electric device. In this case, electric devices to which supplying electric power may be suspended when a main fuse in the relay box is melt down and an electric device to which supplying electric power should be continued can be kept separate from each other. In this manner, the power delivery apparatus relating to the item (2) can deal with design concept such as power supply line of each vehicle flexibly.

In addition, another terminal separate from the aforementioned connecting terminal may be provided as the upstream output portion belonging to the upstream delivering portion, or the connecting terminal may be shared as (served as) the upstream output portion. In view of improvement in workability in the aforementioned subsequent step, it is advantageous that the upstream output portion is another terminal separate from the connecting terminal. In view of reduction in size and cost of the upstream delivering portion (and hence reduction in size and cost of the power delivery apparatus), it is advantageous that the connecting terminal is also used as the upstream output portion.

According to third aspect of the invention, relating to the item (3), electric power can be supplied through the downstream delivering portion to an electric device (such as a starter motor) for which the fuse function in the power delivery apparatus is dispensable. Accordingly, electric power can be supplied through the downstream delivering portion, for example, to an electric device which was connected directly to a battery when the battery is disposed in the engine room (for example, see the background apparatus). Thus, change of design of such an electric device can be avoided.

In addition, a special terminal may be provided in the upstream delivering portion so that electric power can be supplied to such an electric device from the upstream delivering portion.

According to fourth aspect of the invention, relating to the item (4), the power delivery apparatus (downstream delivering portion) can serve for the function as the main fuse usually disposed in the relay box. Accordingly, in a case for example where the capacity of the main fuse increased (to increase the size of the main fuse itself) with the vehicle made highly functional, the shape and internal wiring of the relay box, etc., do not need to be changed substantially. It will go well if the specific fuse portion is provided in the power delivery apparatus (downstream delivering portion) and the power delivery apparatus (downstream delivering portion) and the relay box are connected to each other. In addition, an extremely large number of components, circuits, etc. are generally built in the relay box. Hence, the cost for changing the design of the relay box is higher than the cost for changing the design of the power delivery apparatus. Thus, according to the power delivery apparatus relating to the item (4), it is not necessary to change the design of the relay box for each vehicle, but it is possible to reduce the manufacturing cost of the relay box (and hence the manufacturing cost of the vehicle).

As described above, power delivery apparatuses according to the above aspects of the invention enable users to easily handle battery exhaustion and reduce change of design of various kinds of components as far as possible even when a battery is disposed outside an engine room.

Several aspects of the invention have been described briefly above. The further details of the invention will be made clearer if the following description is read through with reference to the accompanying drawings.

### BRIEF DESCRIPTION OF THE DRAWINGS

FIG. 1 is a schematic view showing an example in which a power delivery apparatus according to a first embodiment of the invention has been applied to a vehicle.

FIGS. 2A and 2B are views for explaining the overall configuration of the power delivery apparatus illustrated in FIG. 1. FIG. 2A is a perspective view in which the power delivery apparatus is observed from a front direction, and FIG. 2B is a perspective view in which the power delivery apparatus is observed from a back direction.

FIGS. 3A and 3B are views showing a state in which a downstream delivering portion of the power delivery apparatus illustrated in FIG. 1 has been separated from an upstream delivering portion. FIG. 3A is a perspective view of the downstream delivering portion, and FIG. 3B is a front view of the downstream delivering portion.

FIG. 4 is a circuit diagram showing a state in which the power delivery apparatus illustrated in FIGS. 2A and 2B has been connected to a relay box.

FIG. 5 is a circuit diagram in which a modification of the power delivery apparatus illustrated in FIG. 2 has been connected to a relay box.

FIGS. 6A and 6B are views showing a state in which a downstream delivering portion of a power delivery apparatus according to a second embodiment of the invention has been separated from an upstream delivering portion. FIG. 6A is a perspective view of the downstream delivering portion, and FIG. 6B is a front view of the downstream delivering portion.

FIG. 7 is a circuit diagram showing a state in which the power delivery apparatus illustrated in FIGS. 6A and 6B has been connected to a relay box.

### DETAILED DESCRIPTION

A power delivery apparatus according to each embodiment of the invention will be described below with reference to the drawings.

### First Embodiment

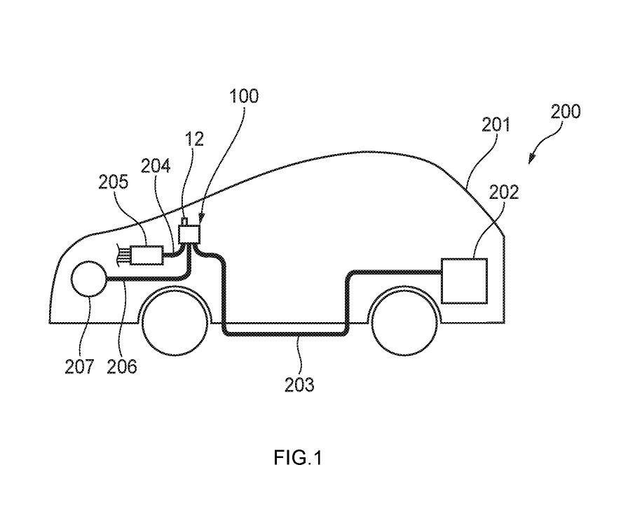

FIG. 1 illustrates a state in which a power delivery apparatus (hereinafter also referred to as “power delivery apparatus 100”) according to a first embodiment of the invention has been applied to a vehicle 200.

As illustrated in FIG. 1, the power delivery apparatus 100 is disposed in a front part of a vehicle body 201 of a vehicle 200 (in particular in an engine room), and a battery 202 (on-vehicle power source) is disposed in a rear part of the vehicle body 201 (in particular in a lower portion of a trunk room). By the power delivery apparatus 100, electric power supplied from the battery 202 through a power path 203 can be supplied to a relay box 205 through a power path 204, and supplied to a starter motor 207 through a power path 206. In addition, the power delivery apparatus 100 may be configured to supply electric power to other electric devices (not-illustrated) in addition to the relay box 205 and the starter motor 207.

The power delivery apparatus 100 has a jump post 12 (external input terminal) which is to be connected to a battery (external power source) of a rescue vehicle through a power line such as a booster cable when battery exhaustion occurs in the vehicle 200 (details will be described later).

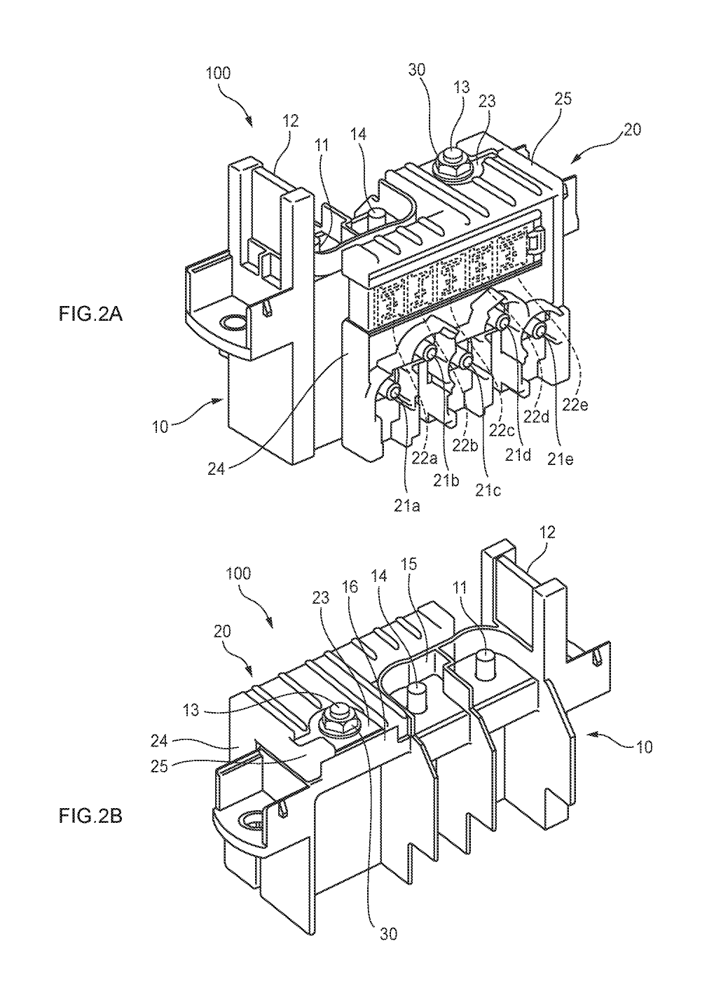

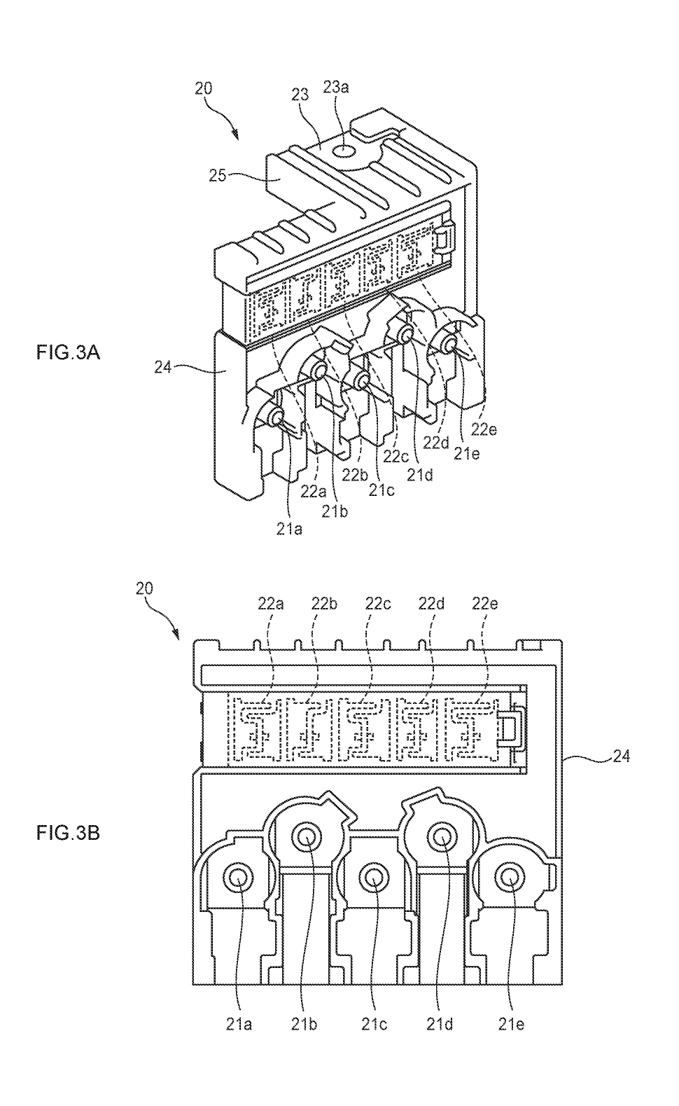

As illustrated in FIGS. 2A and 2B, in the power delivery apparatus 100, an upstream delivering portion 10 and a downstream delivering portion 20 have been assembled and integrated to each other. The upstream delivering portion 10 and the downstream delivering portion 20, however, are members independent of each other, and can be separated from each other (for example, see FIGS. 3A and 3B). In this embodiment, the upstream delivering portion 10 is a common part (general-use component) independent of the type of the vehicle 200, and the downstream delivering portion 20 is an individual part (optional component) designed based on a specification defined uniquely for the type of the vehicle 200.

The upstream delivering portion 10 includes a power source connection terminal 11 (internal input terminal) that can be connected to the battery 202, the jump post 12 (external input terminal), an output terminal 13 (connecting terminal) from which electric power can be outputted to the downstream delivering portion 20, and an output terminal 14 from which electric power can be outputted to the starter motor 207. The power source connection terminal 11 and the output terminals 13 and 14 are terminals shaped like columns, and the jump post 12 is a terminal shaped like a thin plate.

An end portion of the power path 203 extending from the battery 202 is connected to the power source connection terminal 11. An end portion of a power path (such as a booster cable) connected to a battery (external power source) of a rescue vehicle is connected to the jump post 12. An input terminal 23 (connected terminal) of the downstream delivering portion 20, which will be described later, is connected to the output terminal 13. An end portion of the power path 206 extending from the starter motor 207 is connected to the output terminal 14.

The downstream delivering portion 20 includes a plurality (five in this embodiment) of output terminals 21a to 21e (downstream output terminals), fuse portions 22a to 22e (also see FIG. 3B), and the input terminal 23 (connected terminal). A plurality of power paths connected to electric devices of the vehicle 200 can be connected to the output terminals 21a to 21e. The fuse portions 22a to 22e are connected to the output terminals 21a to 21e respectively. Electric power to be supplied to the output terminals 21a to 21e through the fuse portions 22a to 22e respectively is inputted to the input terminal 23. The input terminal 23 (connected terminal) is connected to the output terminal 13 (connecting terminal) of the upstream delivering portion 10. In addition, the number of the output terminals 21a to 21e, the number of the fuse portions 22a to 22c, the capacities of the fuse portions 22a to 22e for the respective output terminals 21a to 21e may be set desirably in accordance with the vehicle model, the type, the specification, etc. of the vehicle 200.

The overall shape of the downstream delivering portion 20 will be described here. The downstream delivering portion 20 includes a front face portion 24 like a longitudinal plate, and a projection portion 25 like a transverse plate. The output terminals 21a to 21e are provided in a central portion in an up/down direction of the front face portion 24. The fuse portions 22a to 22e are located and housed near the upper end of the front face portion 24 (also see FIG. 3B). The projection portion 25 projects rearward from the left half part of the upper end portion of the front face portion 24. The input terminal 23 like a flat plate is provided in a central portion in a left/right direction of the projection portion 25.

The upstream delivering portion 10 has an overall shape as follows. Fringe portions 15 and 16 like fences are provided in an upper end portion of the upstream delivering portion 10 so that the fringe portions 15 and 16 can be fitted to the circumferential edge of an upper end rear portion of the downstream delivering portion 20 when the upstream delivering portion 10 and the downstream delivering portion 20 are assembled. Further, the upstream delivering portion 10 is configured so that a part of the upper face of the upstream delivering portion 10 can come into contact with the lower face of the projection portion 25 of the downstream delivering portion 20 when the upstream delivering portion 10 and the downstream delivering portion 20 are assembled.

As illustrated in FIGS. 3A and 3B, a circular insertion hole 23a is provided in the input terminal 23 of the downstream delivering portion 20. The columnar output terminal 13 of the upstream delivering portion 10 is inserted into the insertion hole 23a, and the output terminal 13 and the input terminal 23 are fastened by a nut 30 (see FIGS. 2A and 2B). Thus, the output terminal 13 of the upstream delivering portion 10 and the input terminal 23 of the downstream delivering portion 20 can be electrically connected to each other, while the upstream delivering portion 10 and the downstream delivering portion 20 can be assembled to each other.

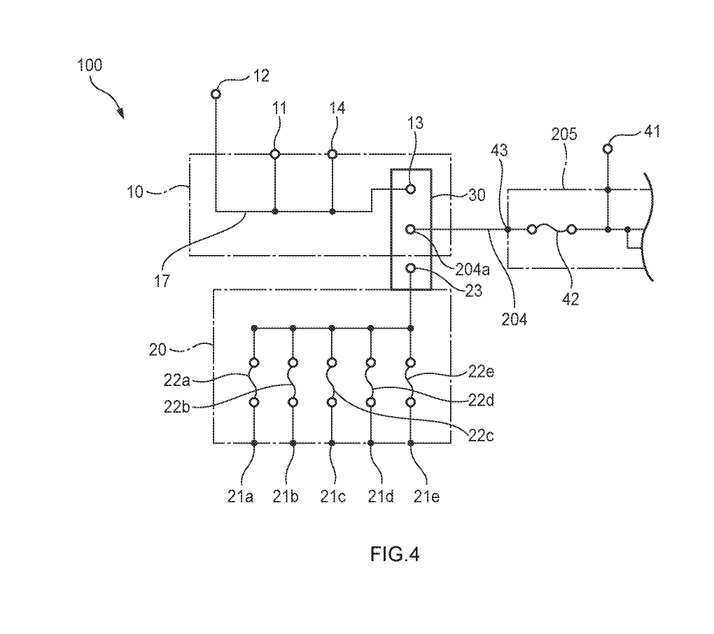

As an example of a use state of the power delivery apparatus 100, an example in which the relay box 205 has been connected to the power delivery apparatus 100 will be described with reference to FIG. 4.

As illustrated in FIG. 4, a branch circuit 17 connected from the power source connection terminal 11 (internal input terminal) to the jump post 12 (external input terminal), the output terminal 13 (connecting terminal) and the output terminal 14 is formed in the upstream delivering portion 10. In the embodiment, not only the input terminal 23 of the downstream delivering portion 20 but also an end portion 204a of the power path 204 extending from the relay box 205 are connected to the output terminal 13. In particular, the end portion 204a of the power path 204 is fastened and fixed to the output terminal 13 together with the input terminal 23 by the nut 30.

The relay box 205 is provided with an output terminal 41 to which a power source system such as an alternator (not illustrated) is connected, a main fuse 42, and a connecting terminal 43 of the power path 204. The power path 204 is connected to the connecting terminal 43 of the relay box 205.

In addition, the plurality (five in the embodiment) of fuse portions 22a to 22e of the downstream delivering portion 20 are connected in series to the input terminal 23 and connected in parallel with one another. Electric devices (not illustrated) can be connected to the output terminals 21a to 21e corresponding to the fuse portions 22a to 22e.

As has been described above, the power delivery apparatus 100 is integrally provided with the power source connection terminal 11 (internal input terminal) that can be connected to the battery 202, the jump post 12 (external input terminal) that can be connected to an external power source, and the fuse portions 22a to 22e corresponding to electric devices of the vehicle 200. Thus, when the power delivery apparatus 100 is, for example, disposed in an engine room and the battery 202 and the power source connection terminal 11 are connected through the power path 203, the jump post 12 can be located in the engine room even if the battery 202 is located outside the engine room. Hence, handling at the time of battery exhaustion is not different from that in the background art. Further, the fuse portions 22a to 22e are also located in the engine room in the same manner as in the background art. Thus, change of design of peripheral components can be avoided as far as possible.

Hence, according to the power delivery apparatus 100, handling at the time of battery exhaustion can be made easy and change of design of various kinds of components can be avoided as far as possible even when the battery 202 is disposed outside the engine room.

Further, according to the power delivery apparatus 100, the upstream delivering portion 10 and the downstream delivering portion 20 are separate parts, which are independent of each other. When the upstream delivering portion 10 is set as a common part (general-purpose component) independent of the type of the vehicle 200 and the downstream delivering portion 20 is set as an individual part (optional component) designed based on a specification required uniquely for the type of the vehicle 200, change of design all over the power delivery apparatus 100 is not required uniquely for the type of the vehicle 200 in comparison with a case where the upstream delivering portion 10 and the downstream delivering portion 20 are not separate parts. Thus, change in the specification of the vehicle 200 can be dealt with easily and at a low cost.

In addition, the upstream delivering portion 10 has the power source connection terminal 11 corresponding to the battery 202, as another terminal than the output terminal 13 (connecting terminal) corresponding to the input terminal 23 (connected terminal) of the downstream delivering portion 20. Accordingly, for example, no other terminal is connected to the power source connection terminal 11 in a state where the upstream delivering portion 10 and the downstream delivering portion 20 have been assembled to each other (a state where the output terminal 13 of the upstream delivering portion 10 and the input terminal 23 of the downstream delivering portion 20 have been connected to each other). Thus, the power delivery apparatus 100 and the battery 202 can be connected to each other only if the battery 202 and the power source connection terminal 11 are connected to each other in a subsequent step (for example, a step of installation on a vehicle in a product delivery destination such as a car maker). Accordingly, workability in the subsequent step can be improved.

Further, as illustrated in FIG. 4, the upstream delivering portion 10 includes an output portion (also used as the output terminal 13) from which electric power can be outputted to another electric device (relay box 205) than the electric devices connected to the output terminals 21a to 21e. Hence, the electric device (relay box 205) to which electric power is supplied from the upstream delivering portion 10 and the electric devices to which electric power is supplied from the downstream delivering portion 20 (the electric devices connected to the output terminals 21a to 21e) can be selected individually and desirably. Accordingly, electric devices to which supplying electric power may be suspended when the main fuse 42 in the relay box 205 is melt down and an electric device to which supplying electric power should be continued can be kept separate from each other. In this manner, the power delivery apparatus 100 can deal with design concept such as power supply line of each vehicle flexibly.

### Modification of First Embodiment

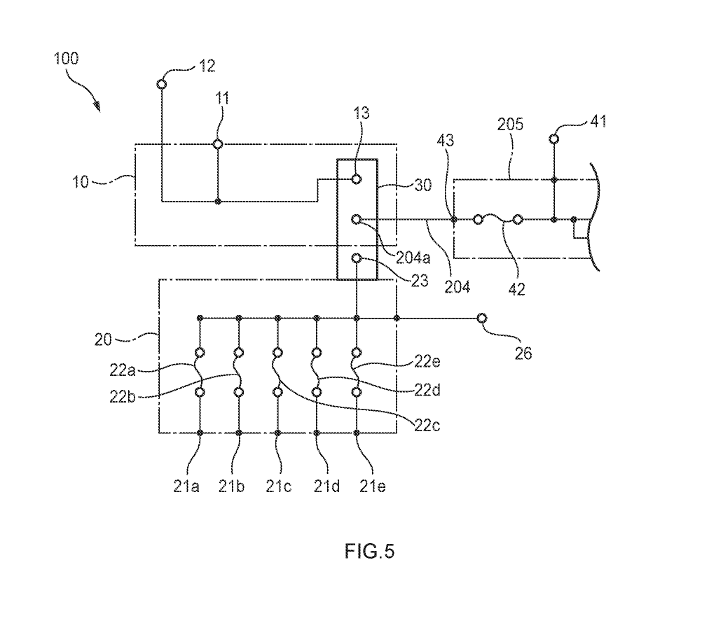

As illustrated in FIG. 5, an output terminal 26 (the output terminal 14 in FIG. 4) connected to the starter motor 207 may be provided not in the upstream delivering portion 10 but in the downstream delivering portion 20. The output terminal 26 (direct output terminal) is connected to an upstream circuit position from the fuse portions 22a to 22e so that electric power can be outputted directly not through the fuse portions 22a to 22e of the downstream delivering portion 20.

According to this configuration, electric power from the battery 202 can be supplied to the starter motor 207 from the downstream delivering portion 20 directly not through the fuse portions 22a to 22e. Accordingly, electric power can be supplied through the downstream delivering portion 20 to an electric device such as the starter motor 207 for which the fuse function in the power delivery apparatus 100 is dispensable. Thus, change of design of such an electric device can be avoided.

### Second Embodiment

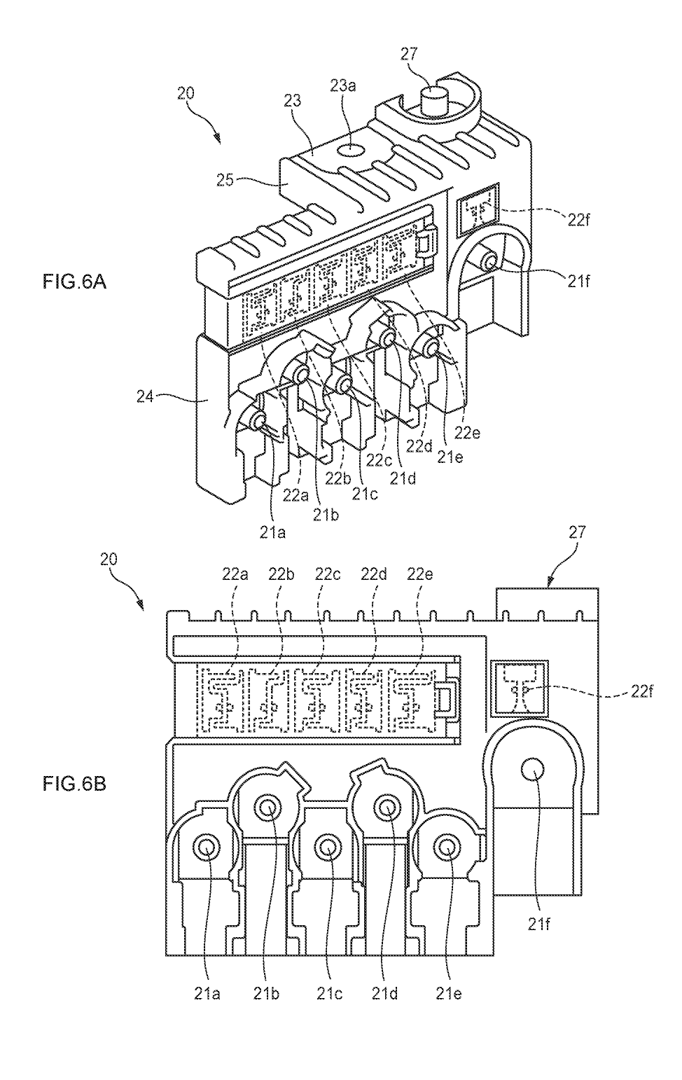

FIGS. 6A and 6B illustrates a downstream delivering portion 20 of a power delivery apparatus (hereinafter referred to as “power delivery apparatus 100A”) according to a second embodiment of the invention. The power delivery apparatus 100A according to the second embodiment is different from the power delivery apparatus 100 according to the first embodiment at the point that the downstream delivering portion 20 includes a specific fuse portion 22f having capacity high enough to serve as the main fuse 42 in the relay box 205.

In particular, as illustrated in FIGS. 6A and 6B, the downstream delivering portion 20 is provided with an output terminal 21f, an output terminal 27, and the specific fuse portion 22f. The power path 204 connected to the relay box 205 of the vehicle 200 can be connected to the output terminal 21f. A power path connected to an alternator (not illustrated) is connected to the output terminal 27. The specific fuse portion 22f can serve as a main fuse (maximum capacity fuse) in the relay box 205. In this embodiment, the output terminal 21f is provided in the front face portion 24 of the downstream delivering portion 20, and the output terminal 27 is provided in the projection portion 25. The specific fuse portion 22f is disposed near an upper part of the output terminal 21f of the front face portion 24 of the downstream delivering portion 20.

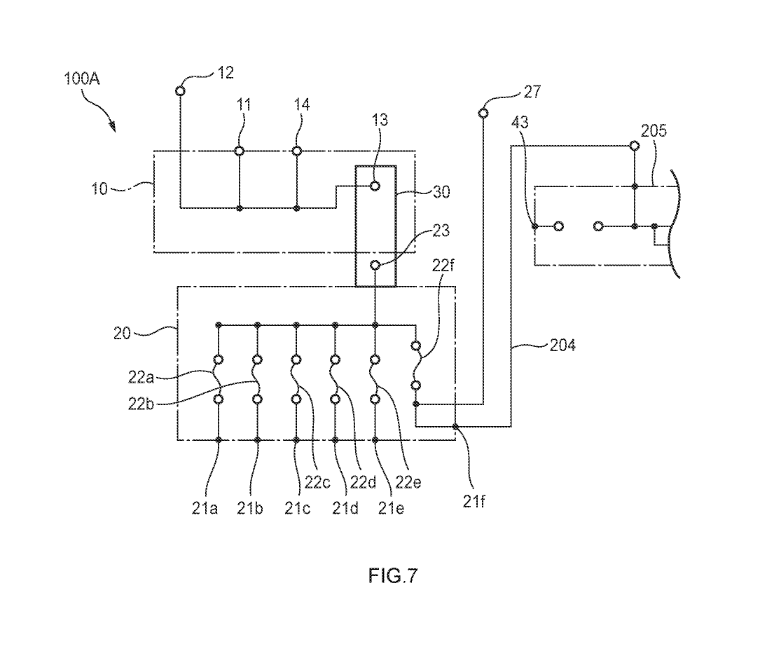

As illustrated in FIG. 7, the specific fuse portion 22f is provided between the input terminal 23 and the output terminal 21f of the downstream delivering portion 20. The power path 204 is connected to connect the output terminal 21f with a downstream circuit position from the position where the main fuse 42 of the relay box 205 should be located (see FIG. 5). In addition, the main fuse 42 is not provided in the relay box 205.

According to this configuration, the power delivery apparatus 100A (downstream delivering portion 20) can serve for the function as the main fuse 42 usually disposed in the relay box 205. Accordingly, in a case where the capacity of the main fuse 42 must be, for example, increased (to increase the size of the main fuse 42 itself) with the vehicle made highly functional, the shape and internal wiring of the relay box 205, etc., do not have to be changed substantially. It will go well if the relay box 205 is connected to the output terminal 21f corresponding to the specific fuse portion 22f of the power delivery apparatus 100A. In addition, an extremely large number of components, circuits, etc. are generally built in the relay box 205. Hence, the cost for changing the design of the relay box 205 is higher than the cost for changing the design of the power delivery apparatus 100A. Thus, it is not necessary to change the design of the relay box 205 for each vehicle 200, but it is possible to reduce the manufacturing cost of the relay box 205 (and hence the manufacturing cost of the vehicle 200).

### Other Forms

In addition, the invention is not limited to the aforementioned embodiments, but various modifications can be used within the scope of the invention. For example, the invention is not limited to the aforementioned embodiments, but changes, improvements, etc. can be made on the invention suitably. In addition, materials, shapes, dimensions, numbers, arrangement places, etc. of respective constituent elements in the aforementioned embodiments are not limited. Any materials, any shapes, any dimensions, any numbers, any arrangement places, etc. may be used as long as the invention can be attained.

Here, the features of the aforementioned embodiments of the “power delivery apparatus” will be summarized and listed briefly in the following paragraphs (1) to (4).

(1)

A power delivery apparatus (100) for a vehicle, the apparatus comprising:

an upstream delivering portion (10) delivering electric power supplied from a power source; and a downstream delivering portion (20) delivering the electric power via the upstream delivering portion (10),

the upstream delivering portion (10) including:

an internal input terminal (11) connected to an on-vehicle power source (202); an external input terminal (12) connected to an external power source outside the vehicle; and a connecting terminal (13) outputting electric power inputted from at least one of the internal input terminal (11) and the external input terminal (12) to the downstream delivering portion (20),

the internal input terminal (11), the external input terminal (12) and the connecting terminal (13) being different terminals from one another,

the downstream delivering portion (20) including:

a connected terminal (23) receiving the electric power outputted from the connecting terminal (13); a fuse portion (22a-22e) connected to the connected terminal (23); and a downstream output terminal (21a-21e) outputting the electric power via the fuse portion (22a-22e) to an electric device mounted on the vehicle,

the upstream delivering portion (10) and the downstream delivering portion (20) being independent members each other and being assembled to be integrated with each other to allow connecting the connecting terminal (13) and the connected terminal (23).

(2)

The power delivery apparatus (100) according to item (1), wherein

the upstream delivering portion (10) includes:

an upstream output portion (the connecting terminal 13 serves as this portion, in the above embodiment, see FIGS. 4 and 5) outputting electric power to another electric device (205) than the electric device connected to the downstream output terminal (21a-21e).

(3)

The power delivery apparatus (100) according to item (1) or item (2), wherein

the downstream delivering portion (20) further includes:

a direct output terminal (26) outputting the electric power inputted to the connected terminal (23) without passing through the fuse portion (22a-22e).

(4)

The power delivery apparatus (100A) according to any one of item (1) to item (3), wherein

the downstream delivering portion (20) includes:

a plurality of the downstream output terminals (21a-21e); and a specific fuse portion (22f) connected to one of the plurality of the downstream output terminals (21a-21e),

the specific fuse portion (22f) having capacity enough to serve as a main fuse (42 in FIGS. 4 and 5) in a relay box (205) mounted on the vehicle.

### REFERENCE SIGNS LIST

100 power delivery apparatus

10 upstream delivering portion

11 power source connection terminal (internal input terminal)

12 jump post (external input terminal)

13 output terminal (connecting terminal)

20 downstream delivering portion

21a-21e, 21f output terminal (downstream output terminal)

22a-22e fuse portion

22f specific fuse portion

23 input terminal (connected terminal)

26 output terminal (direct output terminal)

42 main fuse

200 vehicle

202 battery (on-vehicle power source)

205 relay box

207 starter motor

1. A power delivery apparatus for a vehicle, the apparatus comprising:
an upstream delivering portion delivering electric power supplied from a power source; and a downstream delivering portion delivering the electric power via the upstream delivering portion,
the upstream delivering portion including:
an internal input terminal connected to an on-vehicle power source; an external input terminal connected to an external power source outside the vehicle; and a connecting terminal outputting electric power inputted from at least one of the internal input terminal and the external input terminal to the downstream delivering portion,
the internal input terminal, the external input terminal and the connecting terminal being different terminals from one another,
the downstream delivering portion including:
a connected terminal receiving the electric power outputted from the connecting terminal; a fuse portion connected to the connected terminal; and a downstream output terminal outputting the electric power via the fuse portion to an electric device mounted on the vehicle,
the upstream delivering portion and the downstream delivering portion being independent members each other and being assembled to be integrated with each other to allow connecting the connecting terminal and the connected terminal.

2. The power delivery apparatus according to claim 1, wherein
the upstream delivering portion includes:
an upstream output portion outputting electric power to another electric device than the electric device connected to the downstream output terminal.

3. The power delivery apparatus according to claim 1, wherein
the downstream delivering portion further includes:
a direct output terminal outputting the electric power inputted to the connected terminal without passing through the fuse portion.

4. The power delivery apparatus according to claim 1, wherein
the downstream delivering portion includes:
a plurality of the downstream output terminals; and a specific fuse portion as the fuse portion connected to one of the plurality of the downstream output terminals,
the specific fuse portion having capacity enough to serve as a main fuse in a relay box mounted on the vehicle.
